(19) United States
(12) Patent Application Publication
(10) Pub. No.: US 2022/0396993 A1
(43) Pub. Date: Dec. 15, 2022

(54) HOLDING WEDGE

(71) Applicant: Oldcastle BuildingEnvelope, Inc., Dallas, TX (US)

(72) Inventors: Nathan Patrick, Genessee Depot, WI (US); Conor McDonald, Cleveland, OH (US); Jeffrey James Phillips, Grand Rapids, MI (US); Curtis Massey, Odenton, MD (US); Michael Gordon, Mesa, AZ (US)

(21) Appl. No.: 17/777,004

(22) PCT Filed: Nov. 13, 2020
(86) PCT No.: PCT/US2020/060526

§ 371 Date: May 13, 2022

Related U.S. Application Data
(60) Provisional application No. 62/935,629, filed on Nov. 14, 2019.

(51) Int. Cl. E06B 7/28; E06B 3/26

(52) U.S. Cl. CPC E06B 7/28; E06B 3/26

(57) ABSTRACT

A holding wedge includes a first side and a second side opposite from the first side. The first side and the second side each extend along a length of the holding wedge. The holding wedge also includes a top side that extends between the first side and the second side. The top side of the holding wedge defines a holding channel that extends along at least a portion of the length of the holding wedge.

### REFERENCE TO RELATED APPLICATION

This application claims the benefit of U.S. Provisional Patent Application No. 62/935,629, filed on Nov. 14, 2019 and entitled HOLDING WEDGE, the content of which is hereby incorporated by reference in its entirety.

### FIELD OF THE INVENTION

The field of the invention relates to devices that at least temporarily hold together multiple assembly components as one assembly.

### BACKGROUND

It is common for complex systems such as demountable wall systems or door framing systems to have a number of assembly components that are eventually assembled together to provide the final or finished system. Such assembly components are commonly provided individually and may be assembled at a job side and/or a location offsite from where they are manufactured. Systems that have a large number of assembly components and/or assembly components that are arranged in a particular way may be time-consuming and require storage or other space to prepare, package, and to transport prior to assembly, finish or prepare prior to assembly, and eventually form into an assembled system.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

According to certain embodiments of the present disclosure, a holding wedge includes a first side and a second side opposite from the first side. The first side and the second side each extending along a length of the holding wedge. The holding wedge also includes a top side extending between the first side and the second side and defining a holding channel extending along at least a portion of the length of the holding wedge.

According to some embodiments of the present disclosure, a holding wedge includes a first side, a second side opposite from the first side, and a top side extending between the first side and the second side and defining a holding channel. In some examples, at least one of the first side or the second side extends at an oblique angle relative to the top side.

According to various embodiments of the present disclosure, a holding wedge includes a first side and a second side opposite from the first side. In various examples, the first side and the second side are nonparallel. The holding wedge also includes a top side extending between the first side and the second side and defining a holding channel.

According to some embodiments of the present disclosure, a holding wedge includes a first side defining a first contact location, a second side opposite from the first side and defining a second contact location, and a top side extending between the first side and the second side and defining a third contact location. In certain examples, the holding wedge is configured to apply an expansive force at the first contact location and the second contact location and is configured to apply a compressive force at the third contact location.

According to certain embodiments of the present disclosure, a temporary holding system includes a wall frame system having a first frame component, a second frame component, and a third frame component. The holding system also includes a holding wedge having a first side, a second side opposite from the first side, and a top side extending between the first side and the second side. In various aspects, the holding system is assembled such that the first frame component contacts the first side of the holding wedge, the second frame component contacts the second side of the holding wedge, and the third frame component engages a holding channel defined in the top side of the holding wedge.

According to various embodiments of the present disclosure, a method of holding a wall frame system includes positioning a holding wedge between a first frame component and a second frame component of the wall frame system such that the first frame component contacts a first side of the holding wedge and the second frame component contacts a second side of the holding wedge opposite from the holding wedge and the holding wedge applies an expansive force against the first frame component and the second frame component. The method also includes engaging a third frame component with a top side of the holding wedge extending between the first side and the second side such that the holding wedge applies a compressive force against the third frame component.

Various implementations described in the present disclosure can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures can be designated by matching reference characters for the sake of consistency and clarity.

FIG. 1 is a perspective view of a holding wedge according to aspects of the current disclosure.

FIG. 2 is an end view of the holding wedge of FIG. 1.

FIG. 3 is a top view of the holding wedge of FIG. 1.

FIG. 4 illustrates a method of forming an assembly from assembly components using a holding wedge according to aspects of the current disclosure.

FIG. 5 illustrates a wall frame system with one frame component according to aspects of the current disclosure.

FIG. 6 is another view of the wall frame system of FIG. 5 with two frame components according to aspects of the current disclosure.

FIG. 7 illustrates the wall frame system of FIG. 5 with the holding wedge of FIG. 1 according to aspects of the current disclosure.

FIG. 8 illustrates the wall frame system of FIG. 5 with the holding wedge of FIG. 1 holding the two frame components together as an assembly according to aspects of the current disclosure.

FIG. 9 illustrates the wall frame system of FIG. 5 with the holding wedge of FIG. 1 with three frame components according to aspects of the current disclosure.

FIG. 10 illustrates the wall frame system of FIG. 5 with the holding wedge of FIG. 1 with the holding wedge holding the three frame components together as an assembly according to aspects of the current disclosure.

FIG. 11 illustrates the wall frame system of FIG. 5 with the holding wedge of FIG. 1 with the holding wedge holding the three frame components together as the assembly.

FIG. 12 illustrates the assembly of FIG. 11 being prepared for transport.

FIG. 13 illustrates the assembly of FIG. 11 during a finishing process.

FIG. 14 illustrates a wall frame system with one frame component according to aspects of the current disclosure.

FIG. 15 is another view of the wall frame system of FIG. 14 with two frame components according to aspects of the current disclosure.

FIG. 16 illustrates the wall frame system of FIG. 14 with the holding wedge of FIG. 1 holding the two frame components together as an assembly according to aspects of the current disclosure.

FIG. 17 illustrates the wall frame system of FIG. 14 with the holding wedge of FIG. 1 with the holding wedge holding the three frame components together as an assembly according to aspects of the current disclosure.

FIG. 18 illustrates a wall frame system with a holding wedge holding together components of the wall frame system as an assembly according to aspects of the current disclosure.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “bottom,” “left,” “right,” “front,” and “back,” among others, are intended to refer to the orientation as illustrated and described in the figure (or figures) to which the components and directions are referencing. Any reference to “first,” “second,” “third,” etc. is not used to show a serial or numerical limitation but instead is used to distinguish or identify the various members or components.

Certain aspects and features of the present disclosure relate to a holding wedge for holding a plurality of components together as a one assembly. In some cases, the holding wedge temporarily holds the plurality of components together as one assembly, although in other examples the holding wedge may permanently hold the plurality of components together as one assembly. The holding wedge includes a first side having a first side surface, a second side having a second side surface, and a top side having a top side surface that extends between the first side and the second side. In some examples, the top side includes a holding channel that extends along at least a portion of a length of the holding wedge. In some examples, the holding channel extends along the entire length of the holding wedge.

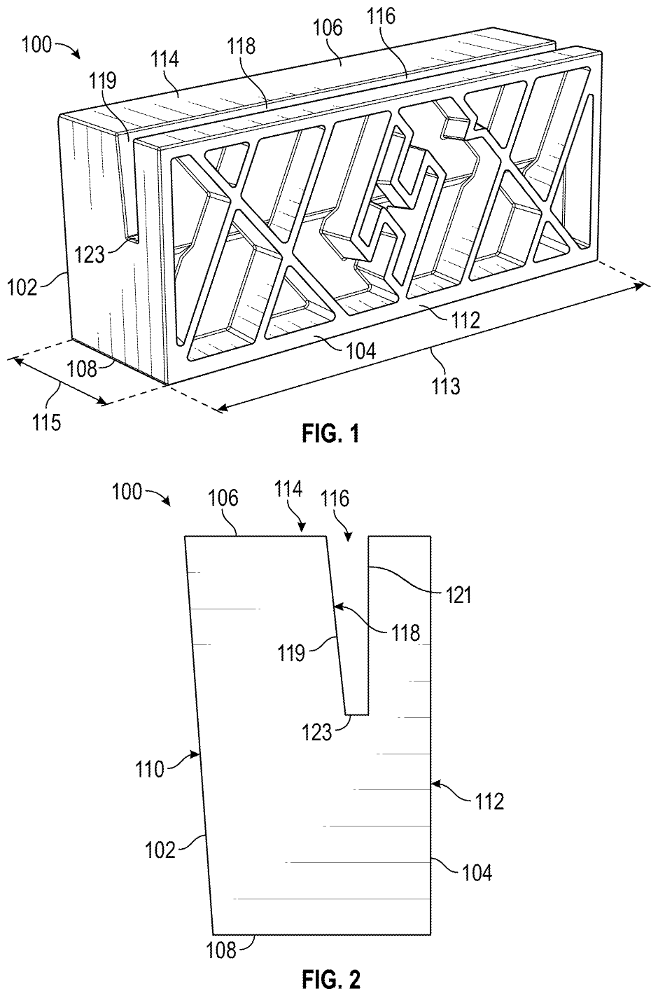

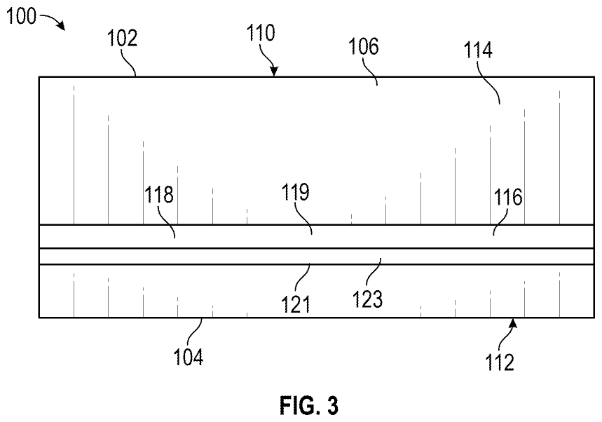

FIGS. 1-3 illustrate an example of a holding wedge 100. As discussed in detail below, the holding wedge 100 may selectively hold a plurality of components together as one assembly. The holding wedge 100 may be constructed from various materials, including, but not limited to, various plastics, rubbers, wood, cardboard, composites, or other suitable materials. In one non-limiting example, the holding wedge 100 may be constructed from acrylonitrile butadiene styrene (ABS). In some cases, the holding wedge 100 may be constructed from materials that are at least partially expandable and/or at least partially compressible. In various non-limiting examples, the holding wedge 100 may be constructed from various materials including, but not limited to, expanded polystyrene (EPS), extruded polystyrene (XPS), polypropylene (PP), expanded polypropylene (EPP), ethylene-vinyl acetate (EVA), and/or polyvinylchloride (PVC).

The holding wedge 100 has a length 113 and a width 115. In certain examples, the length 113 of the holding wedge 100 is greater than the width 115 such that the holding wedge 100 is elongated, although in other examples, the holding wedge 100 may have various shapes, lengths, or widths as desired.

As illustrated in FIGS. 1-3, the holding wedge 100 includes a first side 102, and a second side 104 that is opposite from the first side 102, and a top side 106 that extends between the first side 102 and the second side 104. The holding wedge 100 may also optionally include a bottom side 108 that is opposite from the top side 106. When the bottom side 108 is included, a width of the bottom side 108 may be the same as, greater than, or less than a width of the top side 106. In the example of FIGS. 1-3, the width of the bottom side 108 is less than the width of the top side 106. However, the particular shape or profile of any of the sides 102, 104, 106, 108 should not be considered limiting on the current disclosure, as in various examples any one of the sides may have a particular shape or profile as desired. Moreover, one or more of the sides need not be planar as illustrated, and in other examples one or more of the sides may have one or more portions that are arcuate shaped, angled with respect to another portion of the particular side, or have various other shapes or profiles as desired.

In some examples, at least one of the first side 102 or the second side 104 may extend at an oblique angle relative to the top side 106. In the example of FIGS. 1-3, the first side 102 extends at an oblique angle relative to the top side 106, and the second side 104 is substantially perpendicular to the top side 106. In other examples, both the first side 102 and the second side 104 may extend at oblique angles relative to the top side 106. In some examples, the first side 102 may be substantially parallel to the second side 104, although it need not be in other examples.

The first side 102 includes a first side surface 110, and at least a portion of the first side surface 110 may define a first contact location. In some examples, the entire first side surface 110 defines the first contact location, although in other examples, only a portion of the first side surface 110 that is less than the entire first side surface 110 defines the first contact location. As discussed in detail below, a first component of an assembly may contact the holding wedge 100 at the first contact location. The second side 104 similarly includes a second side surface 112, and at least a portion of the second side surface 112 may define a second contact location. In certain examples, the entire second side surface 112 defines the second contact location, although in other examples, only a portion of the second side surface 112 that is less than the entire second side surface 112 may define the second contact location. As discussed in detail below, a second component of an assembly may contact the holding wedge 100 at the second contact location.

The top side 106 includes a top side surface 114. As illustrated in FIGS. 1-3, in various examples, the top side 106 includes a holding channel 116 having a channel surface 118. In the example of FIGS. 1-3, the holding channel 116 has a tapered profile that decreases in width as the holding channel 116 extends away from the top side surface 114. In some embodiments, at least a portion of the channel surface 118 may extend at an oblique angle relative to the top side surface 114. However, the particular shape or profile of the holding channel 116 should not be considered limiting on the current disclosure, and in other embodiments, the holding channel 116 need not be tapered and/or may have various other shapes or profiles as desired.

In the embodiment of FIGS. 1-3, the channel surface 118 includes a first portion 119, a second portion 121, and a base portion 123 separating the first portion 119 and the second portion 121. As illustrated in FIGS. 1-3, in some optional embodiments, at least a portion of the channel surface 118 may extend at an oblique angle relative to the top side surface 114. In the embodiment of FIGS. 1-3, the first portion 119 extends at an oblique angle relative to the top side surface 114, and the second portion 121 extends at a right angle relative to the top side surface. Optionally, the oblique angle of the first portion 119 may be a supplementary angle to the angle of the first side surface 110, although it need not be in other embodiments. In other embodiments, the channel surface 118 may include fewer or additional portions as desired, and the portions may extend at various angles as desired. As mentioned, the particular shape or profile of the holding channel 116 should not be considered limiting on the disclosure.

In various aspects, the holding channel 116 may extend along at least a portion of the length of the holding wedge 100, and in some examples, the holding channel 116 may extend along the entire length of the holding wedge 100. In the example of FIGS. 1-3, the holding channel 116 extends along the entire length of the holding wedge 100. The holding channel 116 has a depth, and in certain embodiments, the depth of the holding channel 116 is less than a height of the holding wedge 100. Optionally, the depth of the holding wedge 116 may be about ½ or less than the height of the holding wedge 100, although it need not be in other embodiments.

In certain embodiments, the top side 106 of the holding wedge 100 defines a third contact location, and as discussed in detail below, a third component of an assembly may contact the holding wedge 100 at the third contact location. In some examples, the third contact location may be the holding channel 116. Additionally or alternatively, the third contact location may be at least a portion of the top side surface 114.

In various aspects, any or all of the surfaces of the holding wedge 100, including surfaces of the holding channel 116, may optionally have surface features that may be utilized to increase friction between the holding wedge 100 and the components being held by the holding wedge 100. Surface features may include, but are not limited to, textures applied or formed on the surfaces, pressure-sensitive adhesives, combinations thereof, and/or various other suitable techniques or components on the surface(s) to increase friction between the holding wedge 100 and the components.

When used, the holding wedge 100 may at least temporarily hold a plurality of components together as a single assembly. As one non-limiting example, the holding wedge 100 may hold together frame components of a wall frame system as a single assembly. In some examples, the holding wedge 100 may hold the components together as a single assembly by applying an expansive force against components at the first contact location and/or the second contact location, and by applying a compressive force against components at the third contact location. In some cases, the holding wedge may minimize or reduce movement of the components relative to each other. Such holding provided by the holding wedge 100 may minimize or reduce damage that may otherwise occur during various stages of assembling the system due to contact and movement between the components. As some non-limiting examples, the holding wedge 100 may minimize or reduce damage that may otherwise occur during transport of the components to a project side, finishing or other processing of the components (e.g., mitering or shaping) prior to installation, etc. In certain optional examples, the holding wedge 100 may hold the components of the assembly together as a reference assembly to visually indicate how the components should be assembled together after the holding wedge 100 is removed.

In various examples, the holding from the holding wedge 100 may also reduce processing time of the components because multiple components may be processed at the same time as they are held as a single assembly. As a non-limiting example, a door frame system may include three frame components for a right side of a door opening, another three frame components for a left side of the door opening, and another three frame components for a top of the door opening (e.g., nine frame components total). Traditionally, each of the frame components must be cut individually before being assembled (e.g., one cut at a top end of each of the side frame components and two cuts at opposing ends of the top frame components, or twelve cuts total). With holding wedges 100, the frame components forming the right side, the left side, and the top may be pre-assembled as individually assemblies such that all of the components may be cut at the same time. For example, one or more holding wedges 100 may hold together all of the frame components forming the right side of the doorframe system and allow for a single cut to cut all of the frame components at once (rather than three individual cuts). Similarly, one or more holding wedges 100 may hold together all of the frame components forming the top of the door frame system and allow for two cuts to cut all of the frame components at once (rather than six individual cuts). The reduction in the number of cuts may improve the assembly time of the system and reduce costs associated with such cuts.

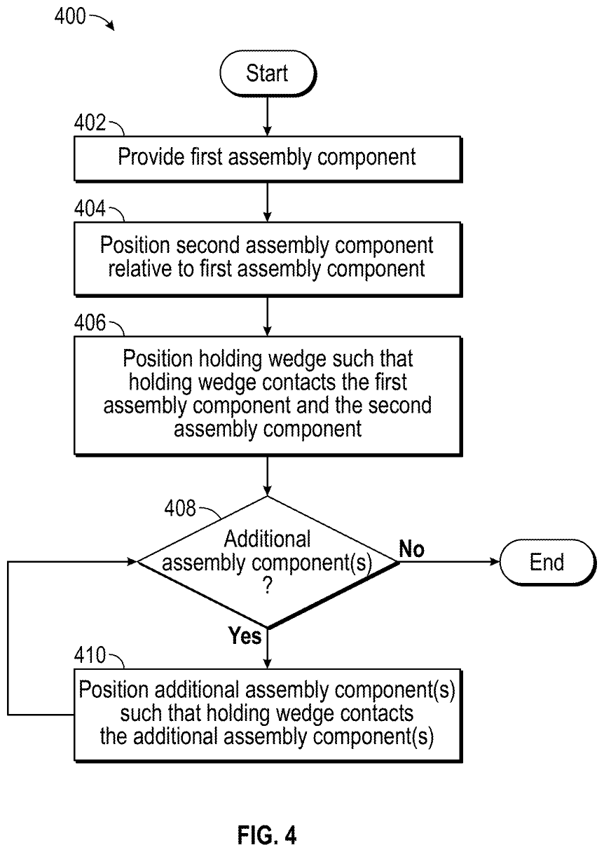

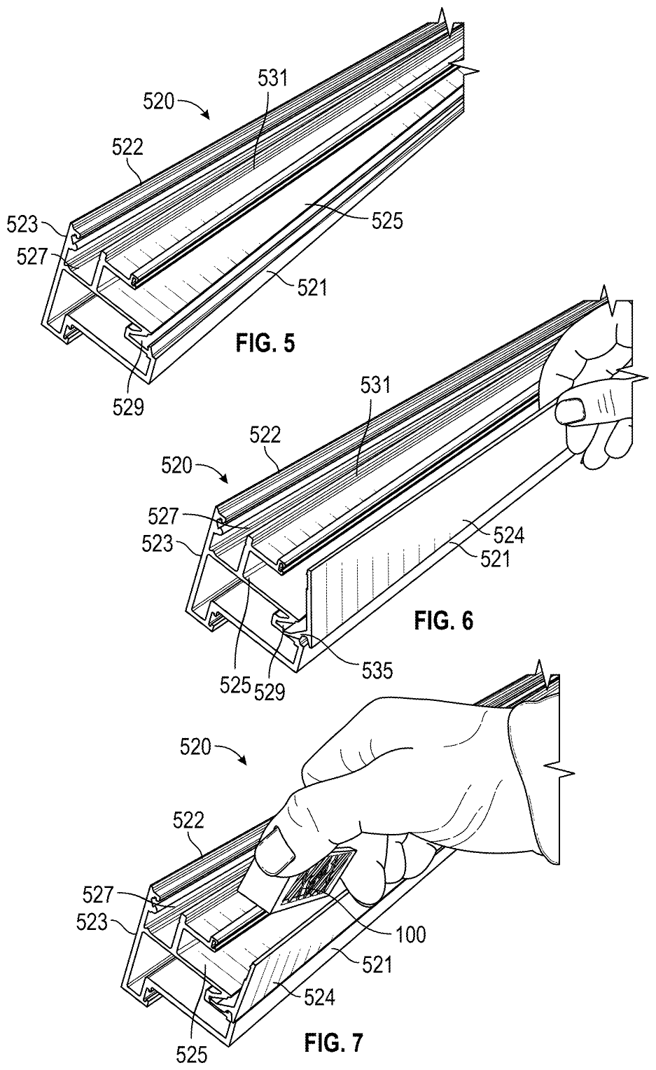

FIG. 4 illustrates various steps during a process of assembling components as a single assembly using the holding wedge 100 and are described in detail below in conjunction with a frame system 520 that is illustrated in FIGS. 5-13. The particular frame system 520 illustrated with the holding wedge 100 should not be considered limiting on the current disclosure, and the holding wedge 100 need not be used with a frame system may be used with various other types of systems, and/or the holding wedge 100 may be used with other types of frame systems as desired. Moreover, while a single holding wedge 100 is illustrated, any number of holding wedges 100 may be utilized as desired.

Referring to block 402 and FIG. 5, the method can include providing a first assembly component 522 of the frame system 520. In some embodiments, the first assembly component 522 may include a first side 521, a second side 523 opposite from the first side 521, a first channel 525, and a second channel 527. Optionally, the first assembly component 522 may include a locking channel 529. Optionally, a center portion 531 may separate the first channel 525 from the second channel 527. Optionally, at least the first channel 525 may be configured to receive a portion of a wall system, including but not limited to a panel of the wall system. Optionally, gaskets or other biasing members or sealing devices may be supported in channels within the first channel 525 and/or the second channel 527 as desired. In other embodiments, the first assembly component 522 may have fewer or additional features, and the features illustrated may also be modified as desired. As such, the particular first assembly component 522 should not be considered limiting on the disclosure.

Referring to block 404 and FIG. 6, the method can include positioning a second assembly component 524 relative to the first assembly component 522. In some cases, positioning the second assembly component 524 may include at least partially engaging or loosely assembling the second assembly component 524 with the first assembly component 522 such that the second assembly component 524 is movable relative to the first assembly component 522. Optionally, positioning the second assembly component 524 may include positioning a locking portion 535 of the second assembly component 524 within the locking channel 529. Optionally, positioning the second assembly component 524 may include positioning the second assembly component 524 such that the second assembly component at least partially covers the first channel 525 at the first side 521. The particular second assembly component 524 should not be considered limiting on the disclosure as the second assembly component 524 may have additional features, fewer features, other features, or any other shape or configuration as desired.

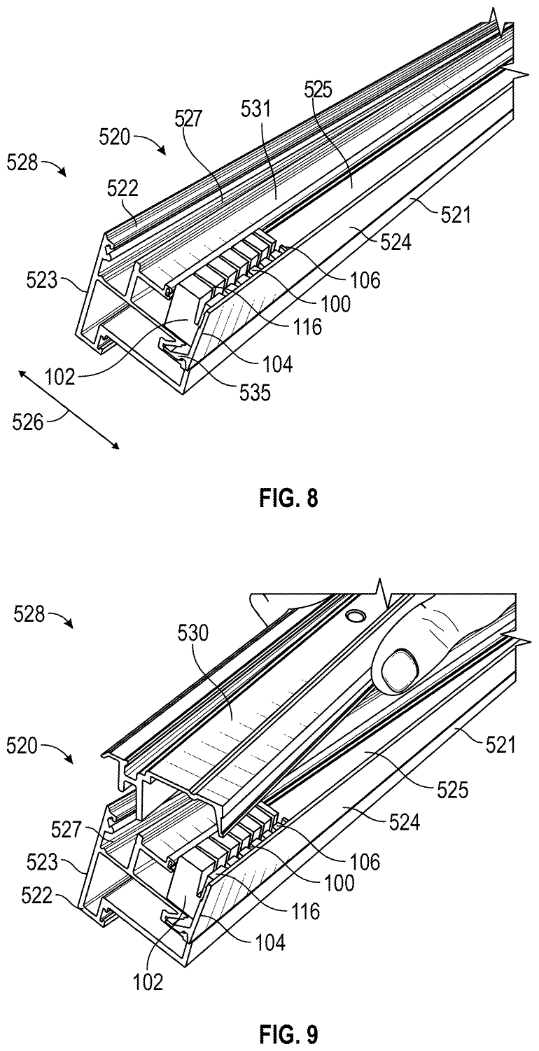

Referring to block 406 and FIGS. 7 and 8, the method can include positioning the holding wedge 100 relative to the first assembly component 522 and the second assembly component 524. In some examples, the holding wedge 100 may optionally be provided with the first assembly component 522 prior to block 404. In various aspects, the holding wedge 100 positioned relative to the first assembly component 522 and the second assembly component 524 holds the assembly components 522, 524 together as a single assembly 528. Optionally, positioning the holding wedge 100 may include at least partially positioning the holding wedge 100 in the first channel 525 and/or between the center portion 531 and the second assembly component 524.

In various aspects, positioning the holding wedge 100 may include engaging the first contact location of the holding wedge 100 with at least a portion of the first assembly component 522 and engaging the second contact location of the holding wedge 100 with at least a portion of the second assembly component 524. Optionally, positioning the holding wedge 100 may include engaging the first contact location of the holding wedge 100 with a portion of the first channel 525, including but not limited to the center portion 531. In some examples, the holding wedge 100 is positioned relative to the first assembly component 522 and the second assembly component 524 such that an outwards or expansive force (represented by arrow 526 in FIG. 8) is applied by the holding wedge 100 against the first assembly component 522 and the second assembly component 524. In other words, the holding wedge 100 may bias that first assembly component 522 away from the second assembly component 524. In other examples, the holding wedge 100 may frictionally engage or otherwise hold the first assembly component 522 relative to the second assembly component to form the single assembly 528.

Referring to block 408, the method can include determining whether additional assembly components are to be joined to the assembly 528.

Referring to block 410 and FIGS. 9-11, if additional assembly components are to be joined to the assembly 528, the method includes positioning the additional assembly component 530 relative to the first assembly component 522, the second assembly component 524, and the holding wedge 100. In some cases, positioning the additional assembly component 530 includes engaging at least a portion of the additional assembly component 530 with the third contact location of the holding wedge 100. Optionally, positioning the additional assembly component 530 may include positioning at least a portion of the additional assembly component 530 within the second channel 527. Optionally, positioning the additional assembly component 530 may include positioning the additional assembly component 530 such that the additional assembly component covers the center portion 531, covers at least a portion of the first channel 525, and/or covers at least a portion of the holding wedge 100.

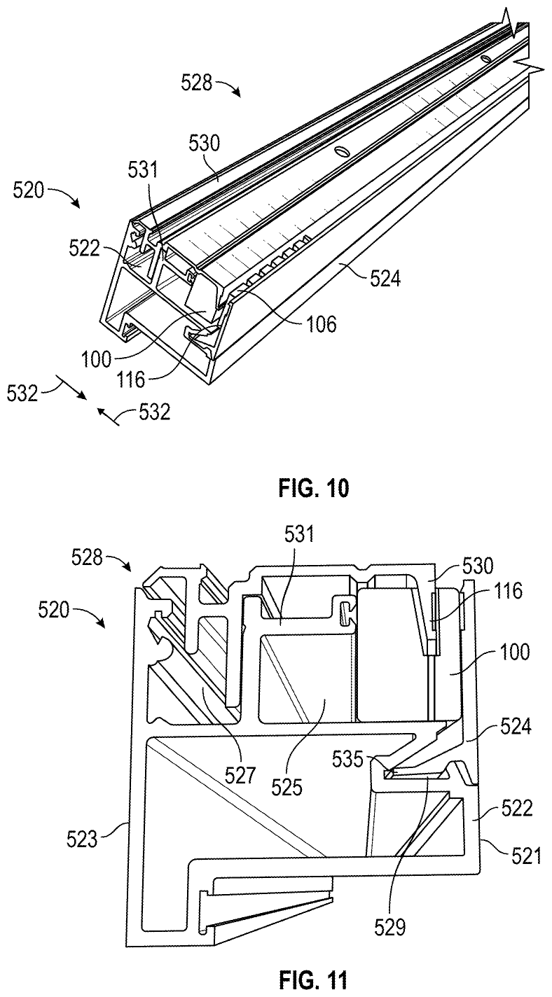

In various examples, positioning the additional assembly component 530 may include positioning at least a portion of the additional assembly component 530 within the holding channel 116 of the holding wedge 100. In some cases, the holding wedge 100 may apply a compressive force (represented by arrows 532 in FIG. 10) against the portion of the additional assembly component 530 within the holding channel 116. In other examples, the holding wedge 100 may frictionally engage or otherwise hold the additional assembly component 530 relative to the other assembly components to form the single assembly 528. The particular additional assembly component 530 should not be considered limiting on the disclosure as the additional assembly component 530 may have additional features, fewer features, other features, or any other shape or configuration as desired.

In block 410, in some optional examples, additional assembly components may actually contact the holding wedge. In other cases in block 410, the assembly components secured by the holding wedge 100 in turn secure additional assembly components that are not actually in contact with the holding wedge 100. In other examples in block 410, additional assembly components are secured by one or more additional holding wedges rather than being in contact with the first holding wedge 100.

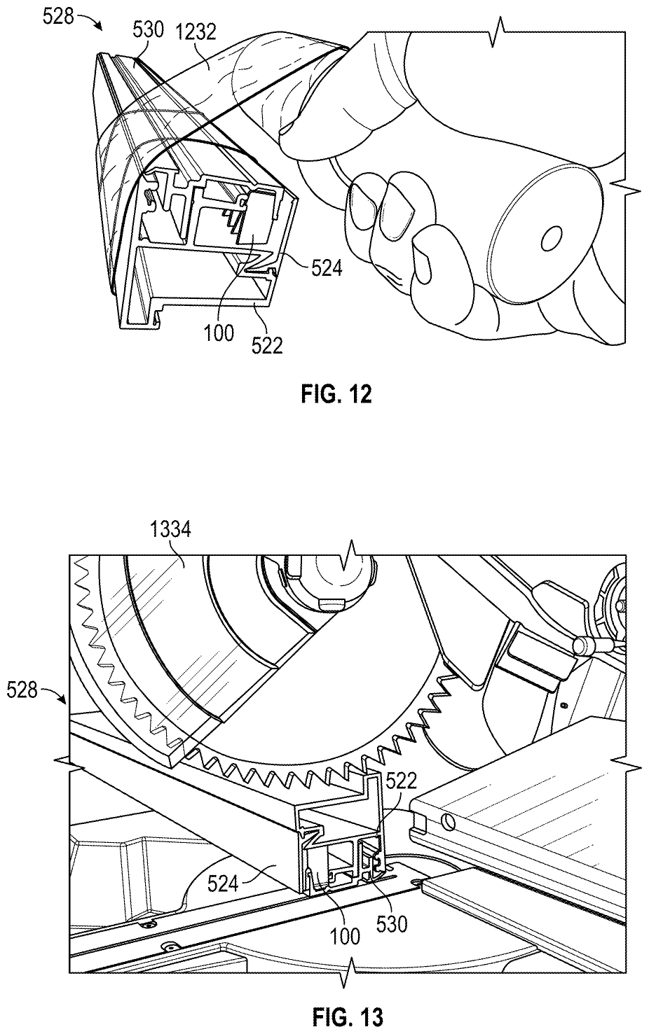

Referring to FIGS. 12 and 13, in various examples, the holding wedge 100 holding together the assembly components may facilitate additional processing of the single assembly 528. For example, referring to FIG. 12, the holding wedge 100 may facilitate packaging (e.g., with wrapping 1232) and/or transport of the frame components by forming the single assembly 528. As another example, and referring to FIG. 13, the holding wedge 100 may allow for a single processing step (e.g., cutting with a saw 1334) to be performed on the plurality of assembly components at the same time.

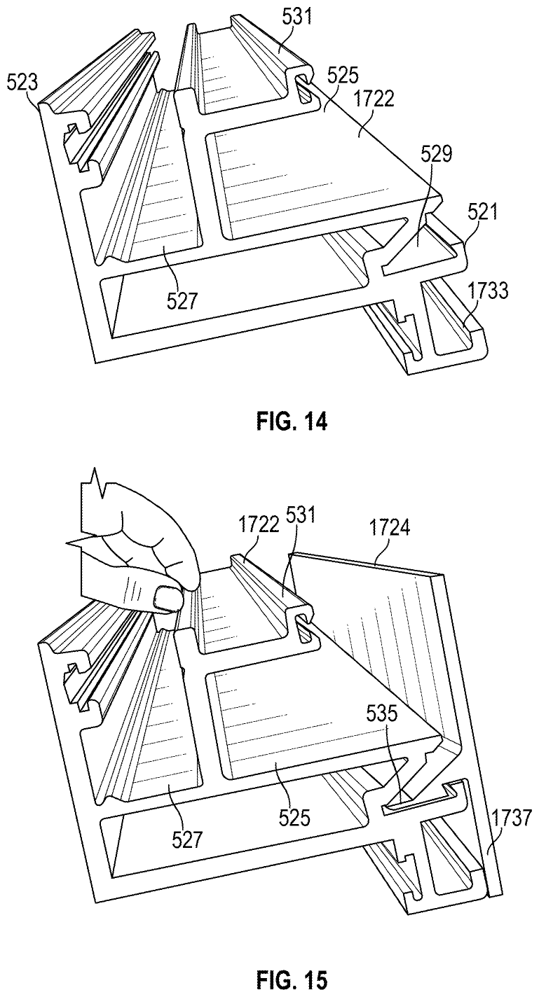

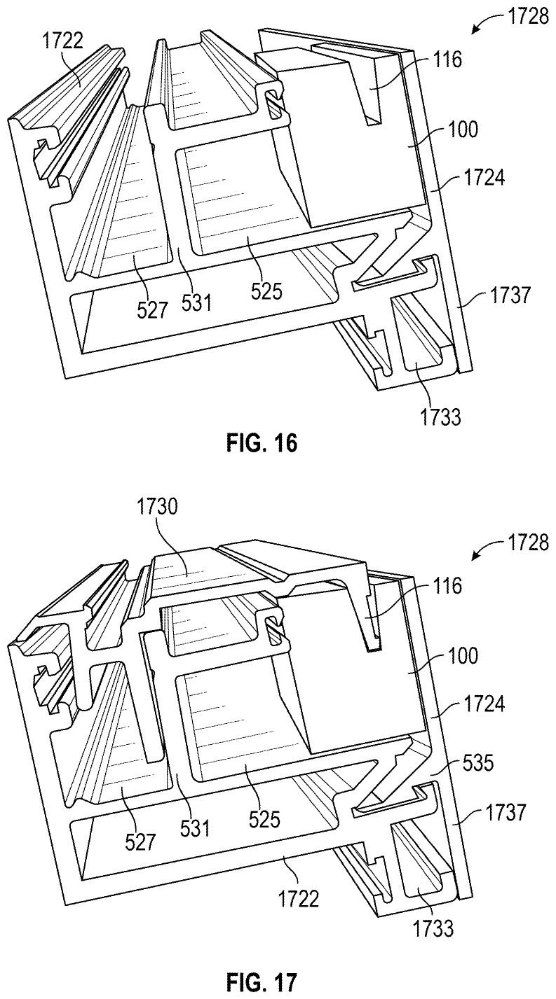

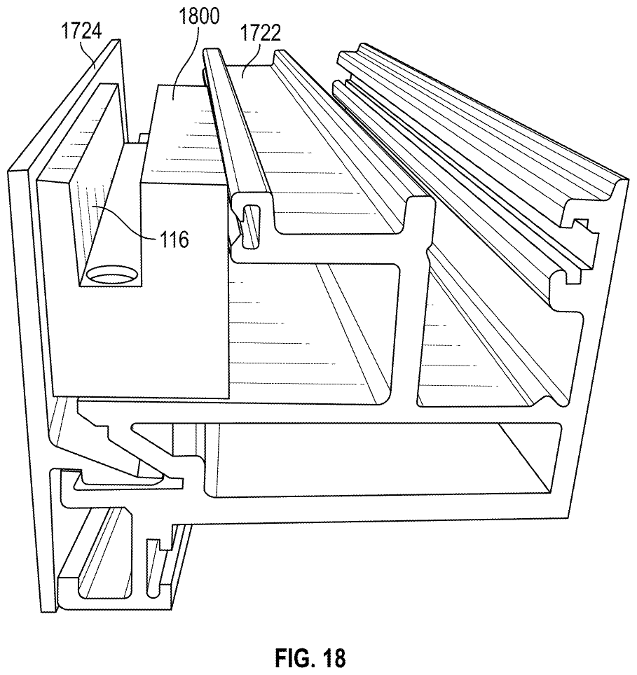

FIGS. 14-17 illustrate another example of steps of forming an assembly 1728 from assembly components 1722, 1724, and 1730 and the holding wedge 100. The assembly component 1722 is substantially similar to the first assembly component 522 except that the assembly component 1722 includes an additional channel 1733 at the first side 521 and below the first channel 522 and/or the locking channel 529. Optionally, a gasket or other suitable biasing or sealing member may be positioned within the additional channel 1733, although various other components may be positionable within the additional channel 1733 as desired. The assembly component 1724 is substantially similar to the second assembly component 524 except that the assembly component 1724 includes an extension 1737 below the locking portion 535 that selectively covers the additional channel 1733. The assembly component 1730 is substantially similar to the additional assembly component 530.

FIG. 18 illustrates another example of a holding wedge 1800. Compared to the holding wedge 100, the profile of the holding wedge 1800 and the profile of the holding channel 116 is different. In addition, while the holding wedge 100 is a plastic material, the holding wedge 1800 is a composite material.

A collection of exemplary embodiments are provided below, including at least some explicitly enumerated as “Illustrations” providing additional description of a variety of example embodiments in accordance with the concepts described herein. These illustrations are not meant to be mutually exclusive, exhaustive, or restrictive; and the disclosure not limited to these example illustrations but rather encompasses all possible modifications and variations within the scope of the issued claims and their equivalents.

Illustration 1. A holding wedge comprising: a first side and a second side opposite from the first side, the first side and the second side each extending along a length of the holding wedge; and a top side extending between the first side and the second side and defining a holding channel extending along at least a portion of the length of the holding wedge, wherein the holding wedge is configured to temporarily hold together at least two components of an assembly.

Illustration 2. The holding wedge of any preceding or subsequent illustrations or combination of illustrations, wherein at least one of the first side or the second side extends at an oblique angle relative to the top side.

Illustration 3. The holding wedge of any preceding or subsequent illustrations or combination of illustrations, wherein the first side extends at an oblique angle relative to the top side, and wherein the second side extends at a right angle relative to the top side.

Illustration 4. The holding wedge of any preceding or subsequent illustrations or combination of illustrations, wherein the holding wedge is a plastic material.

Illustration 5. The holding wedge of any preceding or subsequent illustrations or combination of illustrations, wherein the holding channel comprises a tapered profile that decreases in width as the holding channel extends away from the top side surface.

Illustration 6. The holding wedge of any preceding or subsequent illustrations or combination of illustrations, wherein the holding channel comprises a first portion, a second portion, and a base portion separating the first portion and the second portion, and wherein the first portion extends at an oblique angle relative to the top side of the holding wedge.

Illustration 7. The holding wedge of any preceding or subsequent illustrations or combination of illustrations, wherein the oblique angle of the first portion of the holding channel is a supplementary angle to an angle of the first side of the holding wedge relative to the top side.

Illustration 8. The holding wedge of any preceding or subsequent illustrations or combination of illustrations, wherein the first side defines a first contact location, the second side defines a second contact location, and the top side defines a third contact location, and wherein the holding wedge is configured to temporarily hold together the at least two components of the assembly by engaging a first component of the at least two components of the assembly at the first contact location or the second contact location and by engaging a second component of the at least two components of the assembly at the third contact location.

Illustration 9. The holding wedge of any preceding or subsequent illustrations or combination of illustrations, wherein the first side and the second side are nonparallel.

Illustration 10. The holding wedge of any preceding or subsequent illustrations or combination of illustrations, wherein the first side defines a first contact location, the second side defines a second contact location, and the top side defines a third contact location, and wherein the holding wedge is configured to temporarily hold together the at least two components of the assembly by applying an expansive force at the first contact location and the second contact location and by applying a compressive force at the third contact location.

Illustration 11. A holding wedge comprising: a first side defining a first contact location; a second side opposite from the first side and defining a second contact location; and a top side extending between the first side and the second side and defining a third contact location, wherein the holding wedge is configured to apply an expansive force at the first contact location and the second contact location and is configured to apply a compressive force at the third contact location.

Illustration 12. The holding wedge of any preceding or subsequent illustrations or combination of illustrations, wherein the holding wedge is configured to temporarily hold together at least two components of an assembly, and wherein the holding wedge is configured to apply the expansive force at the first contact location or the second contact location to a first component of the at least two components of the assembly, and wherein the holding wedge is configured to apply the compressive force to a second component of the at least two components of the assembly.

Illustration 13. The holding wedge of any preceding or subsequent illustrations or combination of illustrations, wherein at least one of the first side or the second side extends at an oblique angle relative to the top side.

Illustration 14. The holding wedge of any preceding or subsequent illustrations or combination of illustrations, wherein the first side extends at an oblique angle relative to the top side, and wherein the second side extends at a right angle relative to the top side.

Illustration 15. The holding wedge of any preceding or subsequent illustrations or combination of illustrations, wherein the holding wedge is a plastic material.

Illustration 16. The holding wedge of any preceding or subsequent illustrations or combination of illustrations, wherein the holding channel comprises a tapered profile that decreases in width as the holding channel extends away from the top side surface.

Illustration 17. The holding wedge of any preceding or subsequent illustrations or combination of illustrations, wherein the holding channel comprises a first portion, a second portion, and a base portion separating the first portion and the second portion, and wherein the first portion extends at an oblique angle relative to the top side of the holding wedge.

Illustration 18. The holding wedge of any preceding or subsequent illustrations or combination of illustrations, wherein the oblique angle of the first portion of the holding channel is a supplementary angle to an angle of the first side of the holding wedge relative to the top side.

Illustration 19. The holding wedge of any preceding or subsequent illustrations or combination of illustrations, wherein the first side and the second side are nonparallel.

Illustration 20. A temporary holding system comprising: a wall frame system comprising a first frame component, a second frame component, and a third frame component; and a holding wedge comprising a first side, a second side opposite from the first side, and a top side extending between the first side and the second side, wherein the holding system is assembled such that the first frame component engages the first side of the holding wedge, the second frame component engages the second side of the holding wedge, and the third frame component engages a holding channel defined in the top side of the holding wedge.

Illustration 21. The temporary holding system of any preceding or subsequent illustrations or combination of illustrations, wherein the holding wedge applies an expansive force to the first frame component and to the second frame component, and wherein the holding wedge applies a compressive force on the third frame component.

Illustration 22. The temporary holding system of any preceding or subsequent illustrations or combination of illustrations, wherein the holding wedge frictionally engages each of the first frame component, the second frame component, and the third frame component.

Illustration 23. The temporary holding system of any preceding or subsequent illustrations or combination of illustrations, wherein the holding wedge further comprises a bottom side opposite from the top side, and wherein a width of the holding wedge at the bottom side is less than the width of the holding wedge at the top side.

Illustration 24. The temporary holding system of any preceding or subsequent illustrations or combination of illustrations, wherein the first side and the second side of the holding wedge are nonparallel.

Illustration 25. The temporary holding system of any preceding or subsequent illustrations or combination of illustrations, wherein the first side extends at an oblique angle relative to the top side, and wherein the second side extends at a right angle relative to the top side.

Illustration 26. A method of holding a wall frame system, the method comprising: positioning a holding wedge between a first frame component and a second frame component of the wall frame system such that the first frame component contacts a first side of the holding wedge and the second frame component contacts a second side of the holding wedge opposite from the holding wedge and the holding wedge applies an expansive force against the first frame component and the second frame component; and engaging a third frame component with a top side of the holding wedge extending between the first side and the second side such that the holding wedge applies a compressive force against the third frame component.

Illustration 27. A holding wedge comprising: a first side and a second side opposite from the first side, the first side and the second side each extending along a length of the holding wedge; and a top side extending between the first side and the second side and defining a holding channel extending along at least a portion of the length of the holding wedge.

Illustration 28. A holding wedge comprising: a first side; a second side opposite from the first side; and a top side extending between the first side and the second side and defining a holding channel, wherein at least one of the first side or the second side extends at an oblique angle relative to the top side.

Illustration 29. A holding wedge comprising: a first side; a second side opposite from the first side, wherein the first side and the second side are nonparallel; and a top side extending between the first side and the second side and defining a holding channel.

Illustration 30. A holding wedge comprising: a first side defining a first contact location; a second side opposite from the first side and defining a second contact location; and a top side extending between the first side and the second side and defining a third contact location, wherein the holding wedge is configured to apply an expansive force at the first contact location and the second contact location and is configured to apply a compressive force at the third contact location.

The above-described aspects are merely possible examples of implementations, merely set forth for a clear understanding of the principles of the present disclosure. Many variations and modifications can be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described invention, nor the claims that follow.

That which is claimed:

1. A holding wedge comprising:
a first side and a second side opposite from the first side, the first side and the second side each extending along a length of the holding wedge; and
a top side extending between the first side and the second side and defining a holding channel extending along at least a portion of the length of the holding wedge,
wherein the holding wedge is configured to temporarily hold together at least two components of an assembly.

2. The holding wedge of claim 1, wherein at least one of the first side or the second side extends at an oblique angle relative to the top side.

3. The holding wedge of claim 2, wherein the first side extends at an oblique angle relative to the top side, and wherein the second side extends at a right angle relative to the top side.

4. (canceled)

5. The holding wedge of claim 1, wherein the holding channel comprises a tapered profile that decreases in width as the holding channel extends away from the top side surface.

6. The holding wedge of claim 5, wherein the holding channel comprises a first portion, a second portion, and a base portion separating the first portion and the second portion, and wherein the first portion extends at an oblique angle relative to the top side of the holding wedge.

7. The holding wedge of claim 6, wherein the oblique angle of the first portion of the holding channel is a supplementary angle to an angle of the first side of the holding wedge relative to the top side.

8. The holding wedge of claim 1, wherein the first side defines a first contact location, the second side defines a second contact location, and the top side defines a third contact location, and wherein the holding wedge is configured to temporarily hold together the at least two components of the assembly by engaging a first component of the at least two components of the assembly at the first contact location or the second contact location and by engaging a second component of the at least two components of the assembly at the third contact location.

9. The holding wedge of claim 1, wherein the first side and the second side are nonparallel.

10. The holding wedge of claim 1, wherein the first side defines a first contact location, the second side defines a second contact location, and the top side defines a third contact location, and wherein the holding wedge is configured to temporarily hold together the at least two components of the assembly by applying an expansive force at the first contact location and the second contact location and by applying a compressive force at the third contact location.

11. A holding wedge comprising:
a first side defining a first contact location;
a second side opposite from the first side and defining a second contact location; and
a top side extending between the first side and the second side and defining a third contact location,
wherein the holding wedge is configured to apply an expansive force at the first contact location and the second contact location and is configured to apply a compressive force at the third contact location.

12. The holding wedge of claim 11, wherein the holding wedge is configured to temporarily hold together at least two components of an assembly, and wherein the holding wedge is configured to apply the expansive force at the first contact location or the second contact location to a first component of the at least two components of the assembly, and wherein the holding wedge is configured to apply the compressive force to a second component of the at least two components of the assembly.

13. The holding wedge of claim 11, wherein at least one of the first side or the second side extends at an oblique angle relative to the top side.

14. The holding wedge of claim 11, wherein the first side extends at an oblique angle relative to the top side, and wherein the second side extends at a right angle relative to the top side.

15. (canceled)

16. The holding wedge of claim 11, wherein the holding channel comprises a tapered profile that decreases in width as the holding channel extends away from the top side surface.

17. The holding wedge of claim 16, wherein the holding channel comprises a first portion, a second portion, and a base portion separating the first portion and the second portion, and wherein the first portion extends at an oblique angle relative to the top side of the holding wedge.

18. The holding wedge of claim 17, wherein the oblique angle of the first portion of the holding channel is a supplementary angle to an angle of the first side of the holding wedge relative to the top side.

19. The holding wedge of claim 11, wherein the first side and the second side are nonparallel.

20. A temporary holding system comprising:
a wall frame system comprising a first frame component, a second frame component, and a third frame component; and
a holding wedge comprising a first side, a second side opposite from the first side, and a top side extending between the first side and the second side,
wherein the holding system is assembled such that the first frame component engages the first side of the holding wedge, the second frame component engages the second side of the holding wedge, and the third frame component engages a holding channel defined in the top side of the holding wedge.

21. The temporary holding system of claim 20, wherein the holding wedge applies an expansive force to the first frame component and to the second frame component, and wherein the holding wedge applies a compressive force on the third frame component.

22. The temporary holding system of claim 20, wherein the holding wedge frictionally engages each of the first frame component, the second frame component, and the third frame component.

23-26. (canceled)
